(19) United States
(12) Patent Application Publication
(10) Pub. No.: US 2003/0142488 A1
(43) Pub. Date: Jul. 31, 2003

(54) Illuminating apparatus

(76) Inventor: Dieter Feger, Vienna (AT)

Correspondence Address: Martin A. Farber, 866 United Nations Plaza, Suite 473, New York, NY, 10017, US

(21) Appl. No.: 10/331,088

(22) Filed: Dec. 26, 2002

(30) Foreign Application Priority Data
Jan. 29, 2002 (AT) A 135/2002

(51) Int. Cl. F21V 33/00

(52) U.S. Cl. 362/89

(57) ABSTRACT

An illuminating apparatus for a microscope comprises a housing having an opening for passing light through. To this end there is at least one electrical light source in the housing arranged to direct at least one light beam through this opening. There are means for preventing an electrical discharge within the range of the opening and are selected from shielding means and conductive discharge means. Preferably, prevention is effected by a cover for covering the opening and permitting the light beam to penetrate it. This cover means is electrically conductive at least in part and comprises a transparent plate element having at least one surface extending over the opening and including an electrically conductive coating connected to earth potential.

### FIELD OF THE INVENTION

This invention relates to an Illuminating apparatus, particularly comprising a ring-shaped lamp, equipped with at least one electrical light source in a housing, such as an incandescent lamp, a neon lamp or at least one light emitting diode or a series thereof. The light source can also comprise a light guide to guide light of a lamp (or diode) to a light exit opening, in which case the lamp may either be built in the housing or is located externally of it. The respective light source sends at least one illuminating beam through an opening of the housing towards the object.

### BACKGROUND OF THE INVENTION

Such illuminating devices are known to be arranged directly on a microscope, generally in the region of the optics of the microscope, in order to ensure an optimum illumination of an object to be viewed. Since in a variety of applications of the microscope objects have to be viewed which have to be protected against electrostatic charges, known illuminating devices are provided with an electrically conductive shielding provided on the inner surfaces of the housing of the illuminating device, the shielding being connected to ground or earth potential in an electrically conductive manner.

It has been found that this protection of known illuminating devices against an undesirable charge transfer to the object to be viewed is not sufficient, because electrostatic discharging to the object or even to the observer can happen through the unprotected opening, through which the beam is sent to the object. Such an electrical discharge can result in a change or even the destruction of the object to be viewed. This is a disadvantage particularly when monitoring production in the semi-conductor industry or when objects have to be manipulated under the microscope.

For protecting against electrostatic charge transfer, for example to an object, it is known to use electrical light sources, such as neon lamps, which comprise a special coating. However, such specially coated light sources are very expensive. Moreover, it is a further disadvantage that the coating has the tendency to loosen from the light source after a certain time of use so that there is no longer any protection. One has attempted to spray an anti-static spray onto the light source, but also this doe not result in long-time-protection.

GB-A-1,286,745 discloses a ring-shaped illuminating device for microscopes which comprises a housing having a circular aperture for penetration of an objective. This housing has a ring-shaped (or toroid-shaped) cavity where a correspondingly ring-shaped light tube is accommodated. The lower side of this cavity is open, but covered by a ring-shaped filter for filtering undesirable frequencies of the light beam from the light tube.

Ina scanning tunneling microscope according to JP-A-11-16606, a shielding device is provided between a tip of a probe and the object, thus reducing the electrostatic capacity between probe tip and object.

DE-C-197 20 947 discloses a front lens filter for luminescent screens wherein very thin metal coatings on glass prevent adhering of dust and eliminate electrostatic charges.

### SUMMARY OF THE INVENTION

It is an object of the present invention to avoid the disadvantages of known illuminating devices. It is a further object of the invention to provide an illuminating apparatus, by which an undesirable charge transfer is avoided in an optimum way.

These objects are achieved, according to a first aspect of the invention, in that the opening in the housing, through which the light beam of the light source passes, is equipped with a device for preventing an electrical discharge within the range of said opening, wherein the preventing device is selected from shielding devices and conductive discharge devices. Shielding devices need not necessarily be electrically conductive. However, it is preferred to provide with a charge eliminating arrangement.

In any case, the invention will provide that the environment of the object and the surface of the illuminating apparatus which faces the object is free of charge so that this surface could even be touched, e.g. by negligence of the operator, while manipulating an object under the microscope without damaging the object by a discharging effect.

According to a second aspect of the present invention, the preventing device may comprise a cover for covering the opening and for permitting the beam to penetrate it, wherein the cover is electrically conductive at least in part. In this way, a good shielding effect will be achieved. Moreover, this embodiment has the advantage to be able to supplement an existing illuminating apparatus.

The apparatus can be constructed in an especially simple and inexpensive manner, if the cover comprises a metallic grid that is connected to earth potential. In this way, light losses are minimized.

In a further preferred embodiment of the invention, the cover comprises a transparent plate element, being preferably of glass or of a plastic material, which has at least one surface extending over the opening and including an electrically conductive coating connected to earth potential. In this way, both a good shielding and elimination of charges is achieved. Moreover, covering the opening of the housing prevents touching inadvertently the light source and keeps the interior of the cavity, where the light source will ordinarily be accommodated, dust-free. This important, because entering dust reduces the luminosity of the light source over time.

In order to avoid light losses as much as possible, it is preferred if a coating covers at least one individual zone of said surface, and more preferably if the coating on at least one surface of the plate has the form of a grid. This embodiment too provides in a simple manner a well effective protection against any electrostatic charge transfer to the object or to the observer.

If even more considerable light losses are admissible, the coating may consist of an electrically conductive plastic material which is in itself at least partially transparent. This conductivity may either be produced from the properties of the plastic material itself or by certain additions or fillers, such as graphite. Preferred alternatives are conjugated polymers. In any case, partially transparent, electrically conductive plastic materials are relative inexpensive.

### BRIEF DESCRIPTION OF THE DRAWINGS

Further details and advantages will become apparent from the following description of embodiments schematically shown in the drawings, in which

FIG. 1 is a plan view onto a first embodiment of an illuminating apparatus according to the invention; and

FIG. 2 perspective cross-sectional view of an alternative embodiment.

### DETAILED DESCRIPTION OF THE DRAWINGS

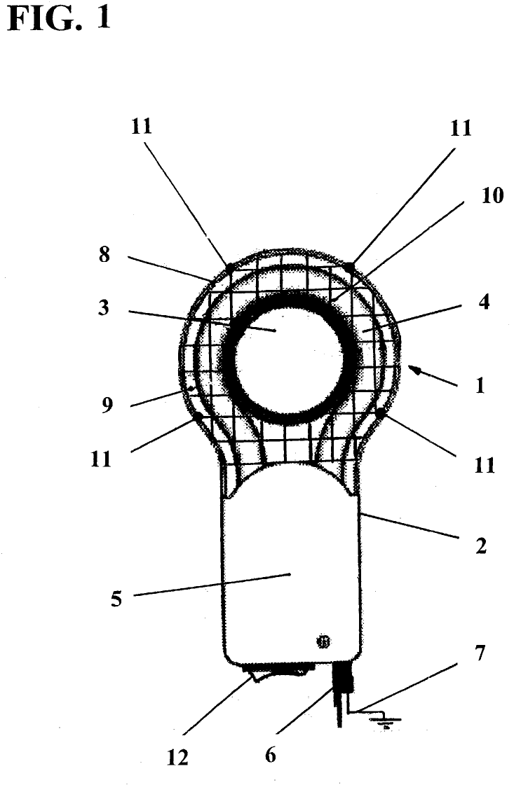

In FIG. 1, an illuminating apparatus 1 for a microscope is shown which is formed as a so-called “ring-light”. This illuminating apparatus 1 comprises a housing 2 that has an aperture 3 for mounting the apparatus in the region of a microscope lens or objective to the microscope. It is generally known to mount an illuminating apparatus 1 so to the microscope that its objective projects into the aperture 3.

The housing 2 forms a cavity in which an electric light source 4 is accommodated, e.g. a fluorescent lamp or tube which extends approximately in an U-shape around the aperture 3 (and the microscope's lens if it is put into the aperture 3). A housing portion 5 includes in a manner known per se the lampholders and the electrical contacts for igniting and supplying the light source 4. Supply of electricity is effected through an electric cable 6 which includes also an electric ground conductor 7.

The cavity, where the light source 4 is accommodated, is wholly open to the side seen in FIG. 1, which is normally the downward directed side. In this way, the lamp 4 is visible through an opening 9 through which the lamp 4 sends its light beams. The inner wall of the housing 2 and its cavity is covered by a metallic layer 8 which is light reflecting and is connected, as known per se, to the earth or ground potential suitably via the conductor 7. This layer 8 forms a reflector for the light of the light source 4 in order to direct as much light through the opening 9 and onto an object in front of the opening 9. Moreover, the layer 8 has the function of a shield and an earth or ground conductor at the rear of the lamp 4.

In order to complete shielding and eliminating of charges also in front of the lamp 4 and in the region of the opening 9, the light emanating opening 9 of the illuminating apparatus 1 is covered by a metallic grid 10 which is also connected to the ground conductor 7, preferably in the region of the peripheral walls of the housing 2 and its cavity. This grid is relative wide-meshed, as shown, for minimizing light losses. On the other hand, it is suitable if it prevents also putting a finger in. Therefore, it is preferred if the grid forms openings of 10 mm times 10 mm in maximum, for example of 5 to 6 mm in square, so as not to allow a finger to pass through. In any case, it may be understood that such a grid can be stiff enough to be self-supporting. Therefore, the thickness of its wire may amount to 1 to 2 mm.

It is suitable to have the grid 10 releasably fastened to the housing 2. This enables retro-fitting an existing illuminating apparatus with the shielding and/or charge eliminating device according to the invention, and allows, in addition, easy access to the lamp 4 for replacing it. To render the grid easily releasable, there are at least three, preferably more, plug-in connector pins 11. In the present embodiment, four pins 11 are provided, but even more can be used. Of course, any releasable connection can be used, as known to those skilled in the art, such as spring clamps and so on. An alternative would be to use screws instead of the pins 11. It is suitable to have at least the bores for receiving the pins 11 or screws made of metal and to connect them to the ground conductor 7, preferably together with the contact made with the reflector 8 of the housing 2.

As has been mentioned above, the grid 10 is suitably dimensioned so that sufficient light may pass through, but also as to render it capable to eliminate any possible electrostatic charge or to shield the interior of the housing's cavity so that an object in front of the opening cannot be damaged by transfer of such charges. Furthermore, the grid prevents contact of fingers with the hot lamp 4. This is not impossible, since practice has shown that fingers may touch the grid 10 when operating a lamp switch 12 for energizing the lamp 4.

The above-mentioned protective measure can be still improved, if the grid has enough distance from the light source 4. It has been found that a distance to the light source of 2 to 5 mm, e.g. 3 to 4 mm, should be maintained. If this distance is chosen, it is even possible to have a larger mesh-size which reduces light losses.

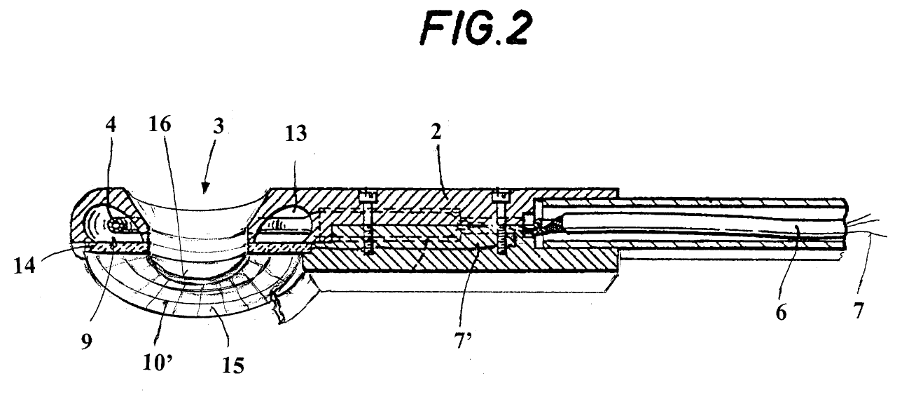

FIG. 2 shows a longitudinal cross-sectional view of the ring light, similar to that of FIG. 1, but adapting a construction according to GB-A-1,286,745 in the gist of the present invention. Therefore, details of this construction will not be explained, but the contents of this document is incorporated here by reference. Instead of a self-supporting grid 10, an electrically conductive grid 10′ is coated onto a glass plate 14 which covers the opening 9 to the cavity 13 in which the lamp 4 is accommodated. Therefore, the glass plate 14 is about circular and covers the opening more or less hermetically so that dust is prevented from entering. Instead of a glass plate, a plate of plastic material, such as acrylic plastic, may be used. Light losses can be diminished, first because the grid 10′ must not be self-supporting and can, therefore, be thinner. On the other hand, luminosity can be further improved, if the coated grid 10′ is of an at least partially transparent plastic material, as discussed above. As shown, there is a connection 7′ between the plate 14 and its grid 10′ and the ground connector wire 7.

Instead of applying the coating 10′ as a grid, any other pattern may be used, for example a linear one (be it circular parallel to the circumference of the plate 14 or transversely to it, or even inclined extending from the inner edge of the plate 14 to the outer one).

Another alternative would be to apply thin metal wires, of e.g. 0.02 to 0.05 mm, to the plate 14. Such wires (or coated grids 10′) may be applied solely to the outer surface 15 of the plate 14 or to the inner surface 16 or to both. In some cases, e.g. with some conjugated plastics used as the plate 14, it would even be possible to embed the grid 10′ or the thin wires.

The invention is not restricted to the use of ring-shaped lamps or tubes 4 but can, of course, also be used in the context of an incandescent lamp or even at least one diode for illuminating a certain spot. Alternatively, a series of diodes placed in the cavity 13, may be used. The lamp itself needs not be accommodated within the cavity 13, but it would also be possible to use light guides for guiding light from an external light source into the interior of the cavity 13. For example a bundle of light guide fibers may be arranged so that their ends are in the plane of the plate 14 which, of course, forms a kind of light guide also in the embodiment of FIG. 2. Eliminating electrical charges is useful even when using light guides, since a charge can also be transferred when touching the ends of light guides or fibers. Furthermore, although a plane grid has been shown and described, a 3-dimesnional one could also be used, for example for enclosing the ring-shaped lamp 4.

What is claimed is:

1. Illuminating apparatus for a microscope, comprising
housing means having an opening;
at least one electrical light source in said housing means arranged to direct at least one light beam through said opening; and
means for preventing an electrical discharge within the range of said opening, said preventing means being selected from shielding means and conductive discharge means.

2. Illuminating apparatus as claimed in claim 1, wherein said light source comprises a ring-shaped lamp.

3. Illuminating apparatus as claimed in claim 1, wherein said light source comprises an incandescent lamp.

4. Illuminating apparatus as claimed in claim 1, wherein said light source comprises a neon lamp.

5. Illuminating apparatus as claimed in claim 1, wherein said light source comprises at least one light emitting diode.

6. Illuminating apparatus as claimed in claim 1, wherein said light source comprises at least one light guiding element.

7. Illuminating apparatus for a microscope, comprising
housing means having an opening;
at least one electrical light source in said housing means arranged to direct at least one light beam through said opening; and
cover means covering said opening and permitting said beam to penetrate them, said cover means being electrically conductive at least in part.

8. Illuminating apparatus as claimed in claim 7, wherein said cover means comprise metallic grid means connected to earth potential.

9. Illuminating apparatus as claimed in claim 8, wherein said grid forms openings 10 mm times 10 mm in maximum.

10. Illuminating apparatus as claimed in claim 8, wherein said grid forms openings of 5 to 6 mm in square.

11. Illuminating apparatus as claimed in claim 8, further comprising releasable fastening means for releasably fastening said grid to said housing.

12. Illuminating apparatus for a microscope, comprising
housing means having an opening;
at least one electrical light source in said housing means arranged to direct at least one light beam through said opening; and
cover means covering said opening and permitting said beam to penetrate them, said cover means being electrically conductive at least in part and comprise a transparent plate element having at least one surface extending over said opening and including an electrically conductive coating connected to earth potential.

13. Illuminating apparatus as claimed in claim 12, wherein said plate element is of glass.

14. Illuminating apparatus as claimed in claim 12, wherein said plate element is of a plastic material.

15. Illuminating apparatus as claimed in claim 12, wherein said coating covers at least one individual zone of said surface.

16. Illuminating apparatus as claimed in claim 15, wherein said coating on said at least one surface has the form of a grid.

17. Illuminating apparatus as claimed in claim 12, wherein said coating consists of an electrically conductive plastic material in itself at least partially transparent.

18. Illuminating apparatus as claimed in claim 7, wherein said cover means is arranged in a distance to said light source of 2 to 5 mm.

19. Illuminating apparatus as claimed in claim 18, wherein said cover means is arranged in a distance to said light source of 3 to 4 mm.
